(19) United States
(12) Patent Application Publication
(10) Pub. No.: US 2005/0243836 A1
(43) Pub. Date: Nov. 3, 2005

(54) Communication interface software system

(76) Inventors: Raymond Truitt, San Antonio, TX (US); Michael D. Garis, San Antonio, TX (US); Edward L. Sanchez, San Antonio, TX (US)

Correspondence Address: Alan R. Thiele;Strasburger & Price, LLP, Suite 4300, 901 Main St, Dallas, TX, 75202, US

(21) Appl. No.: 11/110,478

(22) Filed: Apr. 20, 2005

Related U.S. Application Data
(60) Provisional application No. 60/563,728, filed on Apr. 20, 2004.

(51) Int. Cl. H04L 12/28

(52) U.S. Cl. 370/395.52

(57) ABSTRACT

A communication interface software system that enables simultaneous master/slave communication and IP communication over a bi-directional master/slave bus/communication network.

This application claims the benefit of Provisional U.S. Patent Application 60/563,728 filed Apr. 20, 2004.

### FIELD

The present invention pertains to a communication interface software system for facilitating the sending of data messages conforming to Internet protocol communications standards over a bi-directional communication network which uses a master/slave bus. A master/slave bus has a master terminal and one or more slave terminals connected thereto. The well-known MIL-STD-1553 bus/communication network is one example of a frequently used bi-directional master/slave bus/communication network found on many U.S. military aircraft and vehicles.

### BACKGROUND

Bi-directional master/slave bus networking technology continues to be used on many military and aerospace platforms. The MIL-STD-1553 bus/communications network governs the way that data is transferred from the operators to the equipment onboard aircraft, ships, tanks, missiles, satellites, and the international space station. MIL-STD-1553 also governs the way the equipment onboard aircraft, ships, tanks, missiles, and satellites communicates with other pieces of equipment. Such use of bi-directional master/slave bus/communication networks pre-dates the use of modern, open communication network standards, such as Transmission Control Protocol/Internet Protocol (TCP/IP).

Use of the widely accepted Transmission Control Protocol (TCP) for formatting data messages provides reliable delivery of information to the application level, and use of the widely accepted Internet Protocol (IP) provides instructions for the routing of communications. Because data messages are formatted differently for bi-directional master/slave bus/communication networks from the way that TCP/IP data messages are formatted, those developing software for use on military and aerospace platforms cannot use TCP/IP. Specifically, software developers are restricted by the communication protocols imposed by a bi-directional master/slave bus/network.

While the MIL-STD-1553 is only one example of a bi-directional master/slave bus/communication network, there are many other bi-directional master/slave bus/communication networks in use, including, but not limited to, the following:
MIL-STD-1397C
MIL-STD-1553B
MIL-STD-1760 and MIL-STD-1760C
MIL-STD-1773
ARINC 629
IEEE 1355.2
IEEE std 1393
CanBus ISO 11898
EIA-422
EIA-485
EIA-644

A bi-directional master/slave bus/communication network does not immediately lend itself to TCP/IP communications because of the fundamental difference between the data message formats that are used in a bi-directional master/slave bus/communication network and the data message formats used for TCP/IP datalink networking, including protocols such as IEEE 802.3 (Ethernet). Specifically, a bi-directional master/slave bus/communication network/bus relies on a master terminal to regulate communications over the bus/communication network. The IEEE 802.3 (Ethernet) protocol is for a Carrier Sense Multiple Access (CSMA) decentralized network.

Removal of the data message protocol restrictions on software developers developing products for use in a bi-directional master/slave bus communication network would enable sending data messages using TCP/IP on legacy systems whose communications are based on a master/slave bus/communication network. Thus, the large universe of existing software written for TCP/IP and heretofore not usable on legacy platforms using a master/slave bus/communication network would now become usable on legacy platforms.

Accordingly, a need still remains in the art to improve the communications using bi-directional master/slave bus communication network to enable the use of data messages conforming to TCP/IP without making any major changes to the existing wiring normally associated with a bi-directional master/slave bus/communication network. Additionally, a need remains in the art for a communication interface software system which will also allow legacy messages designed for use with a master/slave bus/communication network to continue to be transmitted to those devices attached to a bi-directional master/slave bus/communication network and which are set up to receive such messages.

### SUMMARY

The communication interface software system of the present invention enables use of TCP/IP data messages over a bi-directional master/slave bus/communication network while, at the same time, allowing for use of data messages and equipment specifically designed for use on a bi-directional master/slave bus/communication network.

The disclosed software system is a communications interface that defines a set of rules which enable Internet protocol communications over a bi-directional master/slave bus/communication network.

The communication interface software system of the present invention embodies a process which enables communication between two devices connected by a bi-directional master/slave bus/communication network to communicate using IP-based protocols. The first step in the process includes encapsulating/decapsulating Internet protocol data using data words which are suitable for transmission over a bi-directional master/slave bus/communication network which allows integration with a TCP/IP message protocol stack on a computing device. The second step in the process includes enabling a first device designed to communicate over a bi-directional master/slave bus/communication network to signal a second device designed to communicate over a bi-directional master/slave bus/communication network that it has a set of IP data packets to be delivered.

The communication interface software system of the present invention embodies a method of encapsulating IP datagrams within data messages suitable for transmission over a bi-directional master/slave bus/communication network having a master terminal and one or more slave terminals. The method includes the steps of encoding the IP datagram into a serial stream that can be broken up and sent from a slave terminal to the master terminal and then decoding the IP datagram after transmission over the bi-directional master/slave bus/communication network.

The communication interface software system of the present invention enables inserting a layer into a communications protocol stack at the sending end of the message. The layer encapsulates the data message being transmitted into a form that may be transmitted over a bi-directional master/slave bus/communication network. The disclosed system also enables inserting a layer at the receiving end of the message that decapsulates the data message being received after the data message has been sent over the bi-directional master/slave bus/communication network.

The communication interface software system of the present invention does not interfere or impede the transmission of any non-IP data messages over the bi-directional master/slave bus/communication network to any device capable of receiving these non-IP data messages over the bi-directional master/slave bus/communication network. If desired, these non-IP data messages may be given priority over an IP data message for transmission over the bi-directional master/slave bus/communication network.

The use of Internet protocol based communications over a bi-directional master/slave bus/communication network provides the advantage of enabling communication of data messages according to standard Internet data communication protocols where heretofore data communication using standard Internet data communication protocols has been impossible over bi-directional master/slave bus/communication networks.

Connections to other communications networks are also enabled by the present invention through the use of routing instructions which are part of the Internet protocol for data transmission. Connections to heterogeneous systems are enabled using a network bridge; more specifically, access may be gained to the widely used reliable Transmission Control Packet/Internet Protocol (TCP/IP) by systems where data communication was limited by the type of bus through which data messages were communicated. This access to the TCP/IP allows freely available functions to be leveraged (e.g., File Transmission Protocol (FTP)). Also, IP datagram traffic and devices operating on a bi-directional master/slave bus/communication network can work together with legacy data messages and legacy equipment.

According to the disclosed communications interface software system, Internet protocol datagrams may now be exchanged between nodes on a bi-directional master/slave bus/communication network. Specifically, the disclosed communications interface software system interacts with a hardware item connected to a bi-directional master/slave bus/communication network, or the disclosed communications interface software system may be embedded into the hardware item itself. The present invention enables any communications protocol which runs “on top” or “over” an Internet protocol communication network to be supported. Exemplary Internet protocols which are now usable in a bi-directional master/slave bus/communication network because of the present invention include, but are not limited to:
TCP/IP for reliable communications
UDP/IP for streaming data
HTTP for transmission of web pages
FTP for transmission of files
VoIP for voice communication

By use of the communication interface software system of the present invention, software developers may create software with an easy migration path for network upgrades. The creation of such software is facilitated by being able to use standard networking concepts and Application Program Interfaces (API).

### BRIEF DESCRIPTION OF THE DRAWING FIGURES

A better understanding of the disclosed communication interface software system may be had by reference to the drawing figures, wherein:

FIG. 1 is a diagram of a data message communication protocol stack according to the Open System Interconnection (OSI) Model;

FIG. 2 is a diagram illustrating how the communication interface software system of the present invention fits into a data message communication protocol stack;

FIG. 3 is a diagram of a networking configuration wherein nodes such as those shown in FIG. 2 are connected to one another in a Local Area Network (LAN) and by a Wide Area Network (WAN) and through the Internet;

FIG. 4 is a diagram of a TCP/IP packet encapsulated in a message being transmitted over a bi-directional master/slave bus/communication network;

FIG. 5 is a table showing example assignments of slave terminal subaddresses;

FIG. 6 is a table showing the first RT Status word, the RTBC Status word;

FIG. 7 is a table showing the second RT Status word, the BCRT Status word;

FIG. 8 is a table showing the defined commands for data transfer from the slave terminal to the master terminal;

FIG. 9 is a table showing the defined commands for a data transfer from the master terminal to the slave terminal;

FIG. 10 is a table showing the structure of the second data word for the BCRT command using two data words communicating the initiation of data transfer.

### DESCRIPTION OF THE EMBODIMENTS

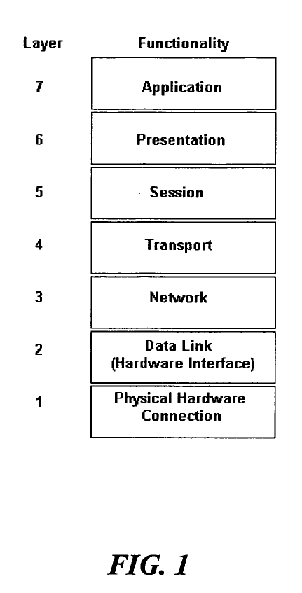

The communication interface software system of the present invention fits into a data message communication protocol stack, such as the Open System Interconnection (OSI) Model shown in FIG. 1.

Working downward from the top of the stack shown in FIG. 1, the Application block at Layer 7 represents the network applications that use the data being transferred; for example, HyperText Transfer Protocol (HTTP) or FTP are two commonly available systems.

The Presentation block at Layer 6 shows where the data is actually encrypted, translated, or compressed before being transmitted.

The Session block at Layer 5 represents the layer at which a connection is established with another computer and, once established, where the connection is maintained between communicating computers.

The Transport block at Layer 4 is where the data is packaged and the transmission of the data tracked to assure that the data packets have been received correctly. The Transmission Control Protocol (TCP) is a protocol within the Transport block.

The Network block at Layer 3 is where routing information is added to each packet of data. The Internet Protocol (IP) is one example of a network protocol within the Network block.

The Transport and Network blocks represent the Protocol Layer.

In the Data Link (Hardware Interface) block at Layer 2, the data packets are prepared for actual transmission through the hardware, including a bi-directional master/slave bus. Transmission problems, such as collisions between data packets, are managed in this block. One example of a protocol within the Data Link block is Ethernet IEEE 802.3.

The Physical block Hardware Connection at Layer 1 represents the actual bus, wiring, and hardware that support the network connection. In a bi-directional master/slave bus/communication network, such as defined by MIL-STD-1553, the master terminal is called a bus controller (BC), and the one or more slave terminals are called remote terminals (RT). In the following description, the abbreviations BC and RT have been used.

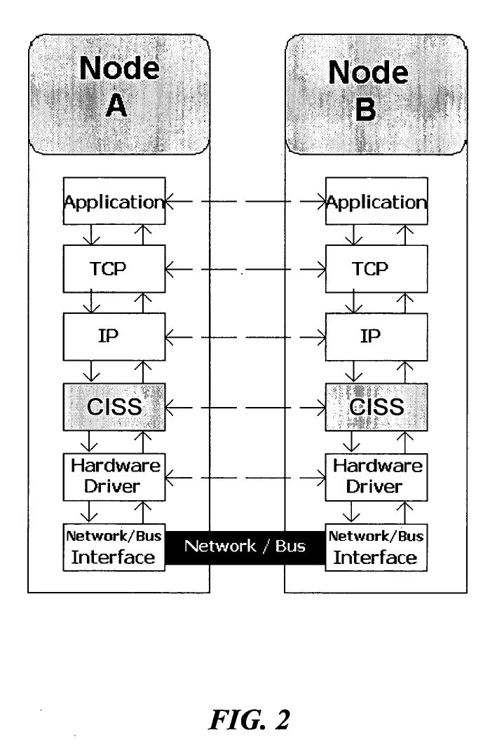

The communication interface software system (CISS in FIG. 2) of the present invention represents a protocol within the Data Link layer to encapsulate/decapsulate data so that the data can be transported over a bi-directional master/slave bus/communication network. FIG. 2 is a more detailed illustration of how the disclosed communication interface software system fits into a communication protocol stack. The box labeled “CISS” indicates the location of the disclosed communications interface software system in the preferred embodiment of the invention. This component also interacts with the slave terminal driver for the interface to the bi-directional master/slave bus/communication network to which a device employing the disclosed system is connected to actually cause the data to be transmitted over the bi-directional master/slave bus/communication network. This software system is responsible for implementing the protocol which arranges the data and performs transmission of the data in such a way that the data can be transmitted to another node on the bi-directional master/slave bus/communication network. That receiving node would then do the work of decapsulating the data from the transmitted message and would then pass that data to the Internet protocol layer for further processing by the Internet protocol stack.

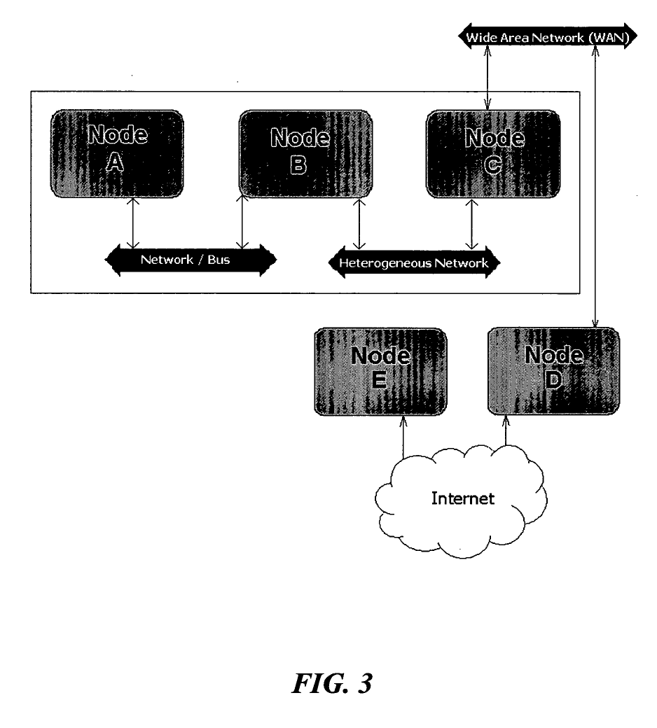

In FIG. 3, a networking configuration is shown in which 2 nodes (labeled “Node A” and “Node B”) are connected by a bi-directional master/slave bus/communication network, and are making use of the disclosed software system to use IP-based communication between these nodes. FIG. 3 also shows “Node C” connected to “Node B” so that nodes A, B, and C make up a Local Area Network (LAN). “Node C” is further connected to “Node D” through a Wide Area Network (WAN), which is further connected to “Node E” through a connection to the Internet. This figure demonstrates the possible nodes of interest that “Node A” is able to communicate with using IP-based communications through the use of the disclosed software system.

FIG. 3 shows that the Internet protocol is a protocol that provides routing capabilities which permits messages to be transmitted not only within a LAN, but also across a WAN (including the Internet). Thus, a node on a bi-directional master/slave bus/communications network can interconnect to a node on an entirely separate network, provided that there is availability of a gateway (or set of gateways) which provides a path to that node through some number of intermediary networks.

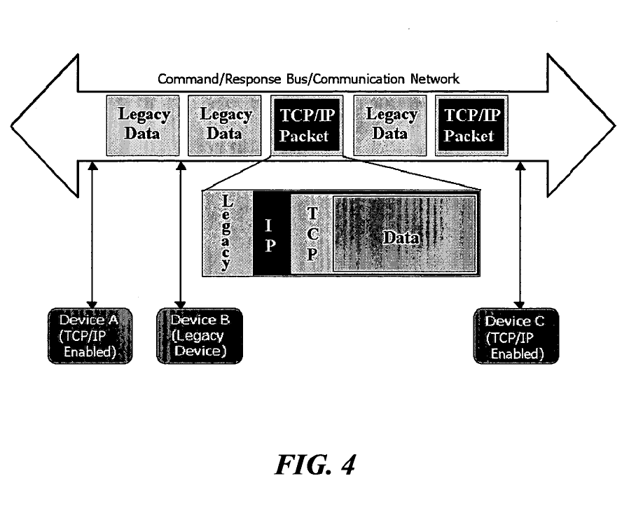

FIG. 4 illustrates a TCP/IP packet encapsulated with a message being transmitted over a bi-directional master/slave bus/communication network, such as that specified by MIL-STD-1553B. At the same time, legacy data messages suitable for transmission over the bi-directional master/slave bus/communication network may be “TCP/IP enabled,” while other nodes or slave terminals on the bi-directional master/slave bus/communication network may not be “TCP/IP enabled.” (Such a device is referred to in FIG. 4 as a “Legacy Device.”)

Additionally, FIG. 3 illustrates that the use of the Internet protocol allows communication not only over and among heterogeneous networks but also heterogeneous operating systems.

The CISS, as shown in FIG. 2, consists of a communications module that interfaces with the Network (IP) layer of the TCP/IP protocol stack and with the slave terminal driver for the interface hardware connecting the device to a master/slave bus/communication network. The disclosed CISS may be configured for IP-based communication on a master terminal controlling traffic over the bus/communications network, or it may be configured for IP-based communication on a slave terminal. In both configurations, the disclosed CISS interfaces with the IP layer by making use of the interface that layer exposes. Similarly, the disclosed CISS interfaces with the slave terminal driver by interacting with the slave terminal routines through the interface exposed. The following two paragraphs give an overview of the operation of the disclosed CISS.

When sending IP-based data from the slave terminal, the disclosed CISS accepts an IP datagram from the IP interface to which it is connected. The IP interface will have been configured to use an MTU of such size that these datagrams are suitable for individual transfer over the master/slave bus/communication network. The CISS of the present invention then interacts with the slave terminal driver for the interface hardware connecting the slave terminal to the master/slave bus/communication network in order to communicate to the destination terminal the fact that it has information to transfer. Finally, upon successfully negotiating with the receiving node to begin communication of the IP-based data, the disclosed CISS interacts with the slave terminal driver to transmit the data chunks across the communication medium, where the receiving node receives them.

When receiving IP-based data to the slave terminal, the CISS of the present invention receives from the slave terminal driver for the interface hardware connecting the slave terminal to a master/slave bus/communication network the set of chunks of data sent by the device's peer (as described above). The disclosed CISS then reconstructs these data chunks into a single IP datagram, and passes this IP datagram to the Network (IP) layer of the TCP/IP protocol stack to which it is connected.

Master Terminal/Slave Terminal Interface

The following paragraphs describe the communication interface between a master terminal (BC) and a single slave terminal (RT), according to the disclosed invention. Any additional slave terminals in the communication network can utilize the protocol established by the master terminal when communicating directly with other slave terminals. Such slave-terminal-to-slave-terminal communication is a feature of the bi-directional bus/communication network described by MIL-STD-1553B. Additional slave terminals are not considered in this description, as they have no impact on how the disclosed protocol operates. The only impact of adding additional slave terminals to the disclosed protocol is the loss of bandwidth used when communicating with slave terminals.

The specific scheme detailed in the following paragraphs is specific to master/slave buses/communication networks that specify the use of configurable “subaddresses” on each slave terminal and on the master terminal. MIL-STD-1553B is an example of such a bus. It is a simple step to abstract this scheme to master/slave bus/communication network technologies with a different underlying addressing specification, while retaining the concepts employed by the scheme introduced herein.

As discussed in the overview of the transfer mechanism given above, IP datagrams destined for a peer device are received from the IP interface with an MTU of such size that these datagrams are suitable for individual transfer over the master/slave bus/communication network. In master/slave bus/communication networks which employ subaddresses, these datagrams can be further divided into “chunks” which are sent together to different subaddresses. This scheme improves the throughput rate of the transmission in such master/slave buses/communication networks.

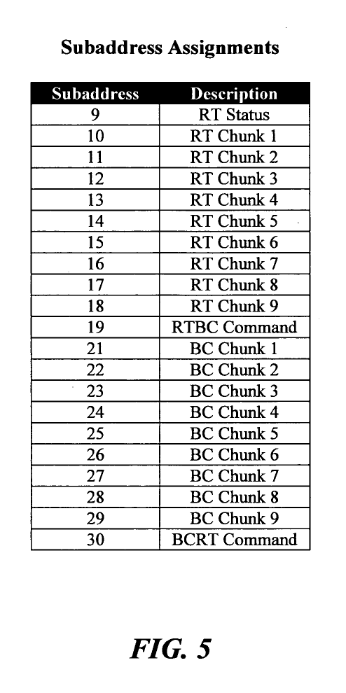

FIG. 5 is a table showing the usage of the slave terminal subaddresses by the disclosed communication interface software system. The specific unique address/subaddress number assigned to the slave terminal is configurable. Use of disclosed communication interface software system is not dependent on a specific assigned slave terminal number. Note further that the subaddress numbers listed in FIG. 5 are also arbitrary; it is merely important that the master terminal and slave terminal agree upon the specific addresses and subaddresses used. Similarly, the number of “RT Chunks” and “BC Chunks” may also be changed freely within the limitations of the specification of the master/slave bus/communication network, provided that both the master terminal and slave terminal agree upon the assignments of addresses and subaddresses. The subaddress assignments detailed in FIG. 5 are only exemplary.

Slave Terminal Status Words

The Slave Terminal Status Word subaddress (denoted “RT Status” in FIG. 5) is used to indicate to the master terminal status information about the slave terminal peer of the master terminal. The slave terminal uses the status word subaddress to communicate to the master terminal in order to indicate the condition that it has data to transfer to the master terminal node. The slave terminal also uses this status word subaddress to communicate to the master terminal to report the status of communications being received from the master terminal. In order to communicate these two sets of information, two data words are made available in the subaddress by the slave terminal for the master terminal to receive and examine. Further explanation of these mechanisms is given below.

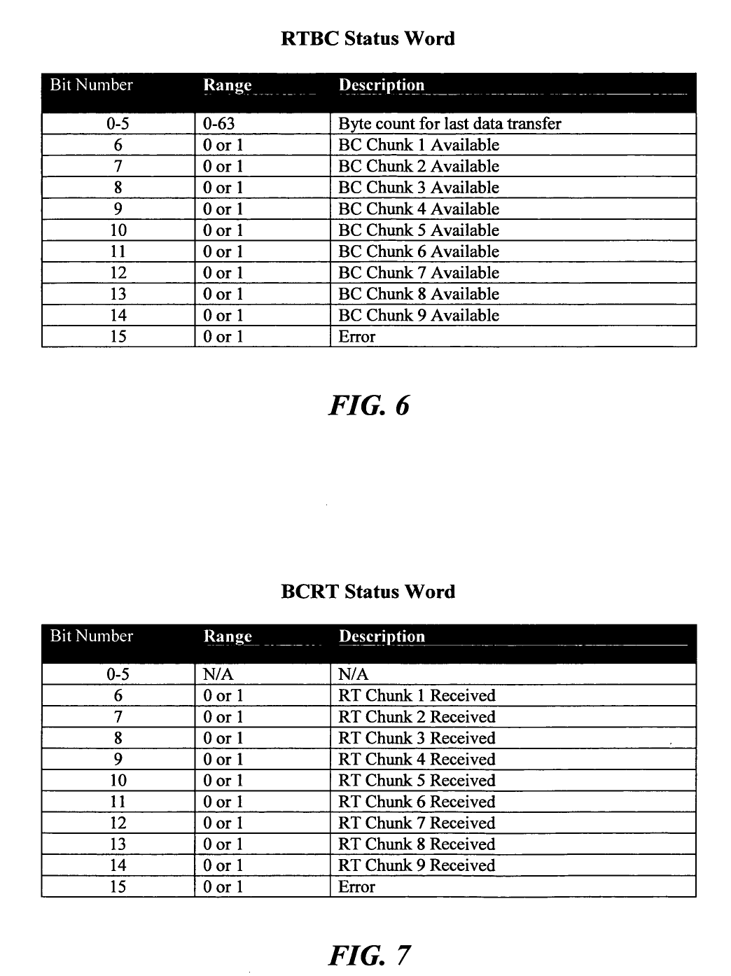

The data word shown in FIG. 6 is the RTBC Status Word. This is the first data word stored in the “RT Status” subaddress. The master terminal polls the subaddress for this word (shown in FIG. 5) on the slave terminal periodically to check to see if the slave terminal is holding any data to be passed on to the master terminal.

Bits 6 through 14 of the RTBC Status Word shown in FIG. 6 represent a Boolean value for whether the corresponding subaddress, as denoted in the table, contains data to be transferred. The last of these subaddresses reported to contain data for transfer is the subaddress bits 0-5 refer to. These first 6 bits shown in FIG. 6 represent the number of bytes of actual data to be transferred are contained in the last chunk of data which is indicated to contain data. A zero in all 5 bits indicates that there are 64 bytes to be transferred in that last chunk of data. The last data bit in the RTBC Status Word depicted in FIG. 6 indicates to the master terminal a situation where the slave terminal has detected an error state.

In addition to being used to signal to the master terminal the fact that the slave terminal has data to send, the RT Status Word subaddress shown in FIG. 5 is also used to indicate to the master terminal the current state of a data transfer from the master terminal to the slave terminal. When sending several chunks of data (which are further divided into the chunks sent in a single transmission group), the master terminal checks status information at this subaddress prior to sending consecutive chunks of data to the slave terminal. This allows the master terminal to be sure that the slave terminal has received all of the data sent in the present chunk before moving to the next chunk of data.

The format used to communicate the status information just described is the BCRT status word shown in FIG. 7. This is the second of two words stored in the “RT Status” subaddress. Bits 6 through 14 are Boolean values that represent whether data has been received at the corresponding subaddress, as shown in FIG. 7. A value of 1 indicates that the corresponding subaddress has not yet been successfully read. A value of 0 indicates that the corresponding subaddress has been read successfully.

When the data transfer is initiated, all subaddresses that will receive data are set to one; they are cleared as they are read.

The last bit of the data word depicted in FIG. 7 is used to indicate to the master terminal an error state. This error state will only be cleared if the slave terminal recovers. Typical errors would be the reception of data in a subaddress that was not supposed to receive data during the data-transfer cycle. When the error bit is set, the master terminal will discontinue any data transfer currently in progress. It will not start a new transfer of data until the error status has been cleared.

RT Data Chunks and BC Data Chunks

In the example subaddress assignment depicted in FIG. 5, nine subaddresses are dedicated to the transfer of data from the master terminal to the slave terminal. Similarly, nine subaddresses are dedicated to the transfer of data from the slave terminal to the master terminal. Data is placed into these subaddresses in numerical order (of the subaddresses), filling each subaddress with as much data as it is allowed to hold before filling the next subaddress, until either there is no more data to fill with, or there are no more available subaddresses to fill.

RTBC Command

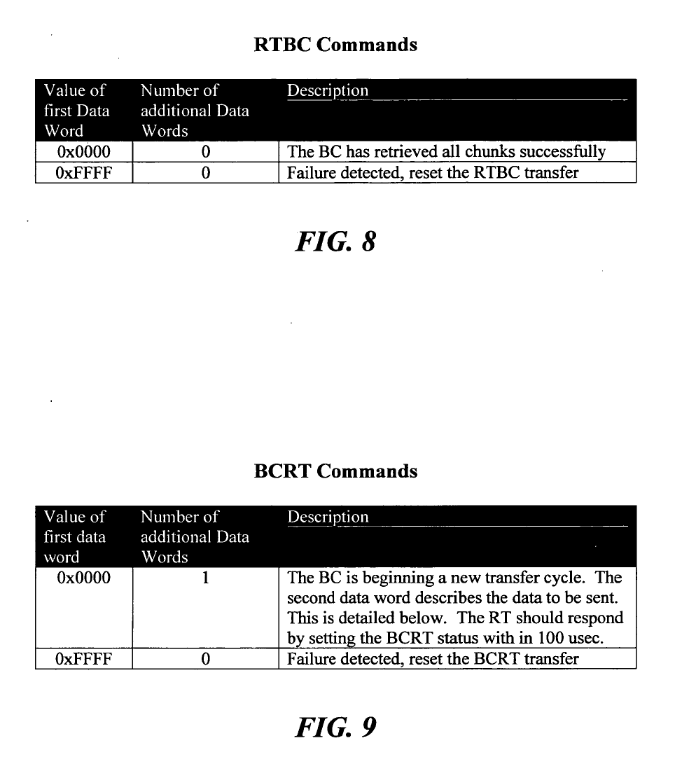

The slave terminal uses the subaddress in FIG. 5 labeled “RTBC Command” to receive commands from the master terminal which are specific to transferring data from the slave terminal to the master terminal. The master terminal uses this subaddress to signal to the slave terminal when the bus controller has successfully retrieved all of the data from the slave terminal in a data-transfer cycle. The possible commands defined for this command data word are shown in FIG. 8.

BCRT Command

The slave terminal uses the subaddress in FIG. 5 labeled “BCRT Command” to receive commands from the master terminal which are specific to transferring data from the master terminal to the slave terminal. The master terminal uses this subaddress to signal to the slave terminal that a data transfer cycle is being initiated, including information about the amount of data to be transferred. The possible commands defined for this command data word are shown in FIG. 9.

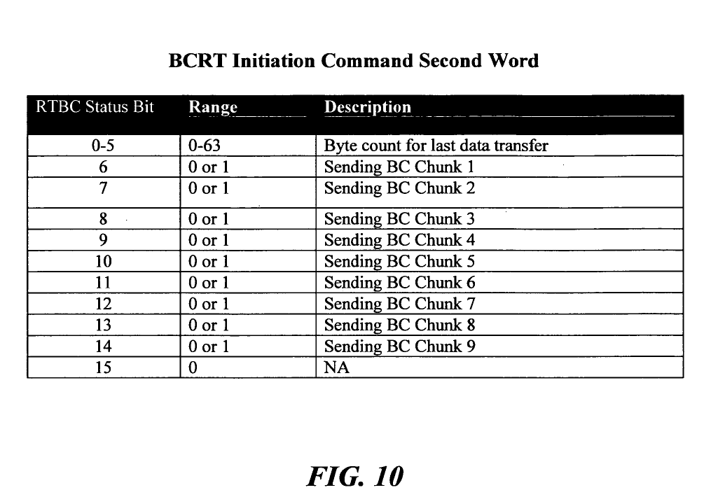

One of these possible commands uses two data words to communicate to the slave terminal. The first word merely contains the code for the command. The structure of the second data word appears in FIG. 10. As is also the case with transfers from the slave terminal to the master terminal, each data chunk should be reassembled in numerical order. Bits 0-5 indicate the number of bytes that will be placed into the last data chunk to be sent. All zeros for bits 0-5 mean that 64 bytes will be sent in the last data chunk to be sent. Bits 6-14 represent Boolean values that indicate whether the corresponding data chunk will be sent.

Slave Terminal to Master Terminal Transfer

When the communication interface software system running in slave terminal mode receives a set of IP datagram from the network (IP) layer it is connected to in the TCP/IP protocol stack, it breaks these Internet protocol datagrams into chunks of data of such size that these chunks of data are suitable for individual transfer over the master/slave bus/communication network. The disclosed communication interface software system then interacts with the slave terminal driver for the interface hardware connecting the slave terminal to the master/slave bus/communication network in order to communicate to the master terminal the fact that it has information to transfer. It does this in the way described in the section above titled “Slave Terminal Status Words.” The disclosed communication interface software system then iterates over the chunks of data it has created, for each chunk, sending the data in that chunk in the manner described in the above sections.

When the communication interface software system of the present invention running in master terminal mode on the peer node receives this data from the slave terminal driver for the interface to the master/slave bus/communication network, it signals successful reception of the data as described in the above section labeled “RTBC Command.” It then reassembles these data chunks into a chunk of data that it passes on to the Network (IP) layer of the TCP/IP protocol stack which accepts these chunks of data which form together to create a whole IP datagram again.

If, during the transfer from the slave terminal to the master terminal, the command from the master terminal to transmit data fails more than a given number of times in a row, the master terminal may assume that an error state exists. This parameter is configurable.

Master Terminal to Slave Terminal Transfer

When the disclosed communication interface software system running in master terminal mode receives a set of IP datagram from the network (IP) layer it is connected to in the TCP/IP protocol stack, it breaks these Internet protocol datagrams into chunks of data of such size that these chunks of data are suitable for individual transfer over the master/slave bus/communication network. The disclosed communication interface software system then interacts with the slave terminal driver for the interface hardware connecting the slave terminal to the master/slave bus/communication network in order to communicate to the slave terminal the fact that it has information to transfer. It does this in the way described in the section above titled “BCRT Command.” The communication interface software system of the present invention then iterates over the chunks of data it has created, for each chunk, sending the data in that chunk in the manner described in the above sections.

When the disclosed communication interface software system of the present invention running in slave terminal mode on the peer node receives this data from the slave terminal driver for the interface to the master/slave bus/communication network, the system signals successful reception of the data as described in the above section labeled “Slave Terminal Status words.” The disclosed communication interface software system then reassembles these data chunks into a chunk of data that it passes on to the Network (IP) layer of the TCP/IP protocol stack which accepts these chunks of data which form together to create a whole IP datagram again.

If, during the transfer of data from the slave terminal to the master terminal, the command from the master terminal to receive data fails more than a given number of times in a row, the master terminal may assume that an error state exists. This parameter is configurable.

Error Conditions

In the event that the disclosed communication interface software system, running in either master terminal mode or in slave terminal mode, detects an error condition such as those described above, it will communicate this error condition to its peer as described in the above sections. The communication interface software system will then reset its state, and communicate the end of the error condition to its peer.

While the communication interface software system of the present invention has been disclosed according to its preferred embodiment, those of ordinary skill in the art will understand that other embodiments have been enabled by the foregoing disclosure. Such other embodiments fall within the scope of the appended claims.

1. A process for enabling communication between two devices connected by a bi-directional master/slave bus/communication network to communicate using IP based protocols, said process comprising the steps of:
encapsulating/decapsulating Internet protocol data with data words suitable for transmission over a bi-directional master/slave bus/communication network which allows integration with a TCP/IP protocol stack on computing device;
providing a means for a first device designed to communicate on a bi-directional master/slave bus/communication network to deliver to a second device designed to communicate on a bi-directional master/slave bus/communication a set of IP data packets to be delivered to said device.

2. The process as defined in claim 1 wherein non-IP based communication between two devices connected by a bi-directional master/slave bus/communication network using a master/slave protocol is not encumbered.

3. The process as defined in claim 2 wherein said non-IP based communication is given a higher priority.

4. A method of encapsulating IP datagrams within data messages suitable for transmission over a bi-directional master/slave bus/communication network having a master terminal and one or more slave terminals, said method comprising the steps of:
encoding the IP datagram into a serial stream that can be broken up and sent between the slave terminal and the master terminal;
decoding the IP datagram after transmission over the bi-directional master/slave bus/communication network.

5. The method as defined in claim 3 further including the step of allowing the transmission of non-IP data messages over the bi-directional master/slave bus/communication network.

6. The method of claim 5 wherein the transmission of said non-IP data messages is given a higher priority.

7. A system for using bi-directional master/slave bus/communication networking technology for communication of data messages, said system allowing for transparent use of communication protocol based on the IP protocol at the application level, said system comprising:
means for inserting a set of protocol instructions into the Data Link layer of a communications protocol stack at the sending end that encapsulates the data message being transmitted into a form that may be sent using bi-directional master/slave bus/communications networking technology;
means for inserting a protocol into a communications protocol stack at the receiving end that decapsulates the data message being received after being sent over bi-directional master/slave bus communications networking technology.

8. The system as defined in claim 7 wherein non-Internet protocol application program interfaces may still be used.

9. The system as defined in claim 8 wherein messaging making use of said non-Internet protocol application program interfaces are given priority.
